(19) United States
(12) Patent Application Publication
(10) Pub. No.: US 2010/0021361 A1
(43) Pub. Date: Jan. 28, 2010

(54) METHODS AND SYSTEMS FOR SELECTIVELY SEPARATING CO2 FROM A MULTI-COMPONENT GASEOUS STREAM

(76) Inventor: DWAIN F. SPENCER, Redding, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/178,479

(22) Filed: Jul. 23, 2008

(51) Int. Cl. B01D 53/62

(52) U.S. Cl. 423/220; 422/170

(57) ABSTRACT

The present invention provides for methods for selectively removing CO₂ from a multi-component gaseous stream to provide a CO₂ depleted gaseous stream. In practicing the subject methods, an initial multi-component gaseous stream is contacted with an aqueous fluid under high-pressure CO₂ hydrate-formation reaction conditions to produce a mixture of a CO₂ hydrate slurry and a CO₂ depleted gaseous stream. Aspects of the subject methods is that the mixture of the CO₂ hydrate slurry and the CO₂ depleted gaseous stream is transferred directly to a second step hydrate formation reactor in a one-stage, two-step process for further removal of CO₂. Also provided are systems that find use in practicing the subject methods. The subject methods and systems find use in a variety of applications where it is desired to selectively remove CO₂ from a multi-component gaseous stream.

### INTRODUCTION

In many applications where mixtures of two or more gaseous components are present, it is often desirable to selectively remove one or more of the component gases from the gaseous stream. Of increasing interest in a variety of industrial applications, including power generation, chemical synthesis, natural or synthetic natural gas upgrading, and conversion of methane hydrates to hydrogen and carbon dioxide (CO₂), is the selective removal of CO₂ from multi-component gaseous streams.

As man-made CO₂ is increasingly viewed as a pollutant, an area in which it is desirable to separate CO₂ from a multi-component gaseous stream is in the area of pollution control. Emissions from industrial facilities, such as manufacturing and power generation facilities, often include CO₂. In such instances, it is often desirable at least to reduce the CO₂ concentration of the emissions. The CO₂ may be removed prior to combustion in some cases and post-combustion in others.

Various processes have been developed for removing or isolating a particular gaseous component from a multi-component gaseous stream. These processes include cryogenic fractionation, selective adsorption by solid adsorbents, gas absorption, and the like. In gas absorption processes, solute gases are separated from gaseous mixtures by transport into a liquid solvent. In such processes, the liquid solvent ideally offers specific or selective solubility for the solute gas or gases to be separated.

Gas absorption finds widespread use in the separation of CO₂ from multi-component gaseous streams. In CO₂ gas absorption processes that currently find use, the following steps are employed: (1) absorption of CO₂ from the gaseous stream by a host solvent, e.g. monoethanolamine; (2) removal of CO₂ from the host solvent, e.g. by steam stripping; and (3) compression of the stripped CO₂ for disposal, e.g. by sequestration through deposition in the deep ocean or in ground aquifers.

Although these processes have proved successful for the selective removal of CO₂ from a multi-component gaseous stream, they are energy intensive and expensive in terms of cost per ton of CO₂ removed or sequestered.

There is continued interest in the development of less expensive and/or less energy intensive processes for the selective removal of CO₂ from multi-component gaseous streams. Of particular interest would be the development of an efficient process which could provide for efficient CO₂ separation from a shifted synthesis gas stream that is rich in CO₂ and that contains primarily CO₂ and hydrogen (H₂).

There is an increasing interest in this application as utilities, energy companies, and the federal government, primarily the Department of Energy (DOE), seek methods to reduce the performance and cost penalties associated with controlling emissions of CO₂ and other emissions, e.g. oxides of nitrogen, from power plants. The DOE is funding the development and demonstration of new processes that employ the gasification of carbon containing fuels.

The gasification process, coupled with the water gas shift reaction, produces shifted synthesis gas that is composed primarily of water vapor (H₂O), CO₂, and H₂. The water vapor may be easily condensed, leaving a mixed gas stream, containing CO₂ and H₂. If the CO₂ is to be sequestered or utilized for secondary or tertiary oil recovery or methane gas recovery from deep coal bed seams, the CO₂ must be essentially free of H₂. Therefore, there is a need for the development of a cost effective, efficient process for separating the component gases of a mixed multi-component gaseous stream, such as a multi-component shifted synthesis gas stream.

### SUMMARY

The present invention provides for methods for selectively removing CO₂ from a multi-component gaseous stream to provide a CO₂ depleted gaseous stream. In practicing the subject methods, an initial multi-component gaseous stream is contacted with an aqueous fluid under high-pressure CO₂ hydrate-formation reaction conditions to produce a mixture of a CO₂ hydrate slurry and a CO₂ depleted gaseous stream. Aspects of the subject methods is that the mixture of the CO₂ hydrate slurry and the CO₂ depleted gaseous stream is transferred directly to a second step hydrate formation reactor in a one-stage, two-step process for further removal of CO₂. Also provided are systems that find use in practicing the subject methods. The subject methods and systems find use in a variety of applications where it is desired to selectively remove CO₂ from a multi-component gaseous stream.

### BRIEF DESCRIPTION OF THE FIGURES

FIG. 1 provides a schematic diagram for the separation of CO₂ from a multi-component gaseous stream according to an embodiment of the subject invention.

FIG. 2 provides a schematic diagram for the separation of CO₂ from a multi-component gaseous stream according to an embodiment of the subject invention.

### DETAILED DESCRIPTION

The present invention provides for methods for selectively removing CO₂ from a multi-component gaseous stream to provide a CO₂ depleted gaseous stream. In practicing the subject methods, an initial multi-component gaseous stream is contacted with an aqueous fluid under high-pressure CO₂ hydrate-formation reaction conditions to produce a mixture of a CO₂ hydrate slurry and a CO₂ depleted gaseous stream. Aspects of the subject methods is that the mixture of the CO₂ hydrate slurry and the CO₂ depleted gaseous stream is transferred directly to a second step hydrate formation reactor in a one-stage, two-step process for further removal of CO₂. Also provided are systems that find use in practicing the subject methods. The subject methods and systems find use in a variety of applications where it is desired to selectively remove CO₂ from a multi-component gaseous stream.

Before the present invention is described in greater detail, it is to be understood that this invention is not limited to the particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

In further describing the subject invention, the subject methods are described first in greater detail, followed by a review of representative embodiments of systems of the subject invention in which the subject methods find use.

### Methods

As summarized above, the subject invention provides methods for selectively removing CO₂ from a multi-component gaseous stream. Embodiments of the subject method provide for resource efficient separation of CO₂ from the multi-component gaseous stream to produce a high-pressure CO₂ product from the separated CO₂. In certain embodiments, the high-pressure CO₂ product is regenerated at a pressure of about 45 atm (e.g. approximately 75% of total regenerated CO₂ is from the first flash reactor) and about 17 atm (e.g. approximately 25% of total regenerated CO₂ is from the second flash reactor). In some cases, the product gas may be subsequently compressed to a pressure of about 100 atm to about 150 atm. Specific pressure ranges of interest for the steps of the subject methods are provided in more detail below.

Because H₂ does not form hydrates under the thermodynamic, temperature, and pressure conditions necessary to form CO₂ hydrates, effective separation of the CO₂ from gaseous streams may be achieved by CO₂ hydrate formation. The first step of the subject methods is to compress the synthesis gas or shifted synthesis gas to a pressure of about 100 atm to about 200 atm. Subsequently, the compressed gaseous stream is contacted with an aqueous fluid under conditions sufficient for CO₂ hydrate formation to occur.

In certain embodiments, the gaseous stream is a multi-component gaseous stream. The multi-component gaseous stream may be any of a variety of different types of gaseous streams, depending on the particular application in which the subject methods are being employed. As such, a variety of multi-component gaseous streams are amenable to treatment according to the subject methods. Multi-component gaseous streams from which CO₂ may be separated according to the subject invention may comprise at least two different gaseous components and may comprise five or more different gaseous components, where at least one of the gaseous components will be CO₂, where the other component(s) may be one or more of N₂, O₂, H₂O, CH₄, H₂, CO and the like, as well as one or more trace gases, e.g. argon, H₂S, SO₂, etc.

In certain embodiments, the multi-component gaseous stream that is subjected to the subject methods is a multi-component syngas stream. The terms “syngas” or “synthesis gas”, as used herein, refer to a multi-component gaseous stream that is generated by the gasification of an organic fuel. The term “gasification”, as used herein, refers to a process that converts an organic fuel into carbon monoxide and hydrogen by reacting the starting material at high temperatures with steam and a controlled amount of oxygen. The gasification process can be represented by the following formula (1):

C+H₂O→H₂+CO (I),

where C represents a carbon-containing organic fuel.

Organic fuels of interest for the gasification process include, but are not limited to: natural gas (e.g. methane), bituminous coal, sub-bituminous coal, lignite, petroleum and petroleum residues, wood, biomass, organic waste streams, and the like. The resulting carbon monoxide from the gasification process can be converted to carbon dioxide and additional hydrogen via the water gas shift reaction, as shown in formula (II), as follows:

CO+H₂O→CO₂+H₂ (II).

In the water gas shift reaction, carbon monoxide reacts with steam to produce carbon dioxide and hydrogen. In certain embodiments, the conversion of carbon monoxide to carbon dioxide and hydrogen may occur via the sour gas shift reaction. In the sour gas shift reaction, the feed gas to the carbon monoxide conversion reaction is not desulfurized.

In certain embodiments, the multi-component gas stream may be a flue gas stream produced by combustion of an organic fuel (e.g. fuels containing primarily carbon) with high purity oxygen. By high purity oxygen is meant a gaseous stream that is at least 90% pure, such as at least 95% pure or purer oxygen. Organic fuels of interest include, but are not limited to: natural gas (e.g. methane), bituminous coal, sub-bituminous coal, lignite, petroleum and petroleum residues, wood, biomass, organic waste streams, and the like.

The weight percentage of CO₂ in the multi-component gaseous streams amenable to treatment according to the subject invention may vary, and in certain embodiments ranges from about 85% to about 95%, such as from about 88% to about 94%, and including from about 89% to about 91%. The weight percentage of H₂ in the multi-component gaseous streams amenable to treatment according to the subject invention may range from about 5% to about 15%, such as from about 8% to about 12%, including from about 9% to about 11%. Also present in the multi-component gaseous streams may be small amounts of trace gases, such as but not limited to carbon monoxide, hydrogen sulfide, nitrogen compounds, and other sulfur compounds. If present, such traces gases are typically not present in amounts exceeding about 3% to about 5%. The partial pressure of CO₂ in the multi-component gaseous stream (e.g. the stream from which water vapor has been previously condensed) need not be high, and may be as low as about 0.85 atm, including as low as about 0.83 atm.

In certain embodiments, the multi-component gaseous stream may be preprocessed from its initial state prior to the first hydrate formation step of the subject methods. For example, in certain embodiments the pressure and/or temperature of the multi-component gaseous stream may be modulated, e.g. raised or lowered, as desired and depending on the initial state of the gas stream. For example, the multi-component gaseous stream may have a temperature of about 22° C. and a pressure of about 27 atm to about 88 atm. The temperature of the gas may be lowered and/or the pressure of the gas may be raised to values desirable for hydrate formation. The initial gas source may also be split into one or more smaller streams, as desired.

In certain embodiments, the pressure of the initial multi-component gaseous stream is increased to produce a compressed multi-component gaseous stream. In some cases, the total pressure of the compressed multi-component gaseous stream when contacted with the aqueous fluid in the first hydrate formation step of the subject methods may be as high as 100 atm or higher, and may range from about 100 atm to about 200 atm, such as from about 100 atm to about 180 atm, including from about 122 atm to about 160 atm. In certain embodiments, the compression energy is then recovered from the compressed multi-component gaseous stream following CO₂ removal. For example, in some cases, compression energy (including, for example, heat energy) from the compressed multi-component gaseous product stream is transferred to the final product gas stream to increase the temperature of the final product gas stream. Compression energy (including, for example, heat energy) may be recovered from the compressed multi-component gaseous stream using any convenient protocol, such as by passing the multi-component gaseous stream through a heat exchanger, or the like. In addition, compression energy may be recovered from the product gas after CO₂ removal by expanding the product gas in a gas expander, or the like. Such embodiments provide significant benefits with respect to reducing overall net energy requirements of the process, which in turn provides for more efficient CO₂ separation.

In certain embodiments, the temperature of the resulting compressed multi-component gaseous steam is reduced to produce a cooled multi-component gaseous stream. In some cases, the temperature of the cooled multi-component gaseous stream ranges from about −1° C. to about 15° C., for example from about 1° C. to about 10° C., such as from about 4° C. to about 8° C., including from about 5° C. to about 7° C.

In the first hydrate formation step of the present methods in which the multi-component gaseous stream is contacted with an aqueous fluid under CO₂ hydrate formation reaction conditions, any convenient aqueous fluid may be employed. Aqueous fluids of interest include, but are not limited to, water, either pure water or salt water, CO₂ nucleated water, e.g. as described in U.S. Pat. Nos. 5,700,311; 6,090,186; and 6,106,595, the disclosures of which are herein incorporated by reference, and the like.

In certain embodiments, the aqueous fluid with which the multi-component gaseous stream is contacted does not include a CO₂ hydrate promoter, e.g., as described in U.S. Pat. Nos. 7,128,777; 6,797,039 and 6,352,576; the disclosures of which are herein incorporated by reference. In these embodiments, the aqueous fluid may not include any exogenous organic compounds, such, as but not limited to halogenated hydrocarbons, low molecular weight alkyl ammonium, sulfonium and phosphonium salts, amines, ethers, or glycols.

In certain embodiments, the multi-component gaseous stream to be treated according to the subject methods is contacted with water that may contain CO₂ hydrate precursors. The CO₂ nucleated water employed in these embodiments of the subject invention comprises dissolved CO₂ in the form of CO₂ hydrate precursors, where the precursors are in meta-stable form. These precursors may be a composite of mixed hydrates containing both CO₂ and promoter molecules. The mole fraction of CO₂ in the CO₂ nucleated water ranges from about 0.01 to 0.10, such as from about 0.02 to 0.08, including from about 0.02 to 0.03. The temperature of the CO₂ nucleated water may range from about −5° C. to about 15° C., for example from about 1° C. to about 10° C., such as from about 4° C. to about 8° C., and including from about 5° C. to about 7° C. The temperature and pressure for formation of CO₂ hydrates may vary. The formation of CO₂ hydrates may occur under conditions where the CO₂ partial pressure ranges from about 0.3 atm to about 200 atm, such as from about 1 atm to about 180 atm, or from about 10 atm to about 150 atm, for example from about 10 atm to about 80 atm, including from about 25 atm to about 60 atm.

The water that is used to produce the nucleated water may be obtained from any convenient source, where convenient sources include, but are not limited to the deep ocean, deep fresh water aquifers, power-plant cooling ponds, and the like, and cooled to the required hydrate reactor conditions. In certain embodiments, CO₂ nucleated water may be recycled from a downstream source, such as from one or more flash reactors (as described in greater detail below) where such recycled CO₂ nucleated water may be supplemented as necessary with additional water, which water may or may not be newly synthesized nucleated water as described above.

The amount of CO₂ that is dissolved in the water is determined in view of the desired CO₂ mole fraction of the CO₂ nucleated water to be contacted with the gaseous stream. One means of obtaining CO₂ nucleated water having relatively high mole fractions of CO₂ is to produce a slurry of CO₂ hydrates and then decompose the hydrates by lowering the pressure and/or raising the temperature of the slurry to release CO₂ and regenerate a partially nucleated water stream. Generally, nucleated water having higher mole fractions of CO₂ is desired because it more readily accepts CO₂ absorption or adsorption and accelerates the formation of other hydrate compounds. By high mole fraction of CO₂ is meant a mole fraction of about 0.02 to 0.06, such as from about 0.025 to 0.055.

The production of CO₂ nucleated water if necessary may conveniently be carried out in a nucleation reactor. The reactor may be packed with a variety of materials, where particular materials of interest are those which promote the formation of CO₂ nucleated water with hydrate precursors and include: stainless steel rings, carbon steel rings, metal oxides, and the like, to promote gas-liquid contact and enhance hydrate precursor formation. To ensure that the optimal temperature is maintained in the nucleation reactor, active coolant means may be employed. Any convenient coolant means may be used, where the coolant means may comprise a coolant medium housed in a container which contacts the reactor, preferably with a large surface area of contact, such as coils around and/or within the reactor or at least a portion thereof, such as the tail tube of the reactor. Coolant materials or media of interest include liquid ammonia, hydrochlorofluorocarbons (HCFCs), and the like. A particular coolant material of interest is ammonia, where the ammonia is evaporated at a temperature of from about −10° C. to about 10° C.

In certain embodiments of the subject invention, the CO₂ nucleated water is prepared by contacting water (e.g. fresh or salt water) with high pressure, substantially pure CO₂ gas provided from an external high pressure CO₂ gas source. In this embodiment, the water is contacted with substantially pure CO₂ gas that is at a pressure that is about equal to or slightly above the initial CO₂ partial pressure in the multi-component gaseous stream. As such, the pressure of the substantially pure CO₂ gas ranges in certain embodiments from about 25 atm to about 50 atm above the multi-component gaseous stream pressure (CO₂ overpressure stimulates hydrate precursor and hydrate formation). By substantially pure is meant that the CO₂ gas is at least 95% pure, such as at least 99% pure and including at least 99.9% pure. Advantages realized in this embodiment include the production of CO₂ saturated water that comprises high amounts of dissolved CO₂, e.g. amounts (i.e., mole fractions) ranging from about 0.005 to 0.025, such as from about 0.01 to 0.02. Additional advantages include the use of relatively smaller nucleation reactors (as compared to nucleation reactors employed in other embodiments of the subject invention) and the production of more CO₂ selective nucleated water. In those embodiments where small nucleation reactors are employed, it may be desirable to batch produce the CO₂ saturated water, e.g. by producing the total requisite amount of CO₂ saturated water in portions and storing the saturated water in a high pressure reservoir. The CO₂ saturated water is readily converted to nucleated water, i.e., water laden with CO₂ hydrate precursors, using any convenient means, e.g. by temperature cycling, contact with catalysts, pressure cycling, etc. This pre-structuring of the hydrate formation water not only increases the kinetics of hydrate formation, but also reduces the exothermic energy release in the CO₂ hydrate reactor. This, in turn, reduces the cooling demands of the process and increases overall process efficiency. In certain embodiments, overall process efficiency is about 90% or higher, such as about 93% or higher, including about 95% or higher, as determined by the parasitic power requirements of the CO₂ separation process.

While the above protocols may be employed to prepare the initial nucleated water, in certain embodiments of interest, following the initial preparation of the nucleated water, additional nucleated water is obtained from the aqueous byproduct produced at the end of the process, such that recycled aqueous byproduct is employed as the nucleated water, as described in greater detail below.

As mentioned above, in the first step of the subject methods, the multi-component gaseous stream is contacted with an aqueous fluid, e.g. CO₂ nucleated water without hydrate promoters, under conditions of CO₂ hydrate formation. The aqueous fluid may be contacted with the gaseous stream using any convenient means. In certain embodiments, means of contacting the aqueous fluid with the gaseous stream are those means that provide for efficient removal, e.g. by absorption or adsorption which enhances hydrate formation, of the CO₂ from the gas through solvation of the gaseous CO₂ within the liquid phase or direct contact of the CO₂ gas with unfilled hydrate cages, which extract the CO₂ from the multi-component gaseous stream. Means that may be employed include, but are not limited to the following: concurrent contacting means, i.e., contact between unidirectionally flowing gaseous and liquid phase streams; countercurrent means, i.e., contact between oppositely flowing gaseous and liquid phase streams; and the like. Thus, contact may be accomplished through use of a fluidic Venturi reactor, sparger reactor, gas filter, spray, tray, or packed column reactors, and the like, as may be convenient.

Generally, contact between the multi-component gaseous stream and the aqueous fluid is carried out in a hydrate formation reactor. The reactor may be fabricated from a variety of materials, where particular materials of interest are those that catalyze the formation of CO₂ hydrates and include, but are not limited to stainless steel, carbon steel, and the like. The reactor surface, or a portion thereof, may be coated with a catalyst material, such as an oxide of aluminum, iron, chromium, titanium, and the like, to accelerate CO₂ hydrate formation. To ensure that the optimal temperature is maintained in the hydrate formation reactor, active coolant means may be employed. Any convenient coolant means may be used, where the coolant means may include a coolant medium housed in a container which contacts the reactor, such as the exit plenum and tail tube of the reactor, with a boiling aqueous phase. Coolant materials or media of interest include ammonia, HCFCs, and the like. A particular coolant material of interest is ammonia. Where the reactor includes gas injectors as the means for achieving contact to produce hydrates, the reactor may include one or a plurality of such injectors. In such reactors, the number of injectors will range from 1 to about 200 or more, where multiple injectors provide for greater throughput and thus greater hydrate production. Specific examples of various reactors that may be employed for hydrate production are provided in U.S. Pat. No. 6,090,186, the disclosure of which is herein incorporated by reference. In certain embodiments, the hydrate formation reactor is a finned tubular reactor, as described in greater detail in U.S. Pat. No. 6,797,039, the disclosure of which is herein incorporated by reference.

In certain embodiments, the hydrate formation reactor has a heat transfer surface area sufficient to transfer substantially all of said heat of formation energy produced by hydrate formation in said reactor to a coolant medium, e.g. such as those described above. By “substantially all” is meant at least about 95%, such as at least about 98%, including at least about 99% or more. In such embodiments, the hydrate formation reaction may be a convectively cooled tubular reactor, having a length to diameter ratio (L/D) that provides for the desired heat transfer surface area and adequate time for complete CO₂ hydrate formation, where in representative embodiments the L/D ratio ranges from about 1000 to about 6000.

In some cases, the multi-component synthesis gas stream is first subjected to the water gas shift reaction, as shown in formula (II) above. In some cases, the resulting multi-component shifted syngas stream is then cooled to condense water vapor. In certain embodiments, to condense any water vapor in the multi-component gaseous stream, the temperature to which the multi-component gaseous stream is cooled will range from about −5° C. to about 30° C., such as from about 1° C. to about 15° C., including from about 4° C. to about 10° C., for example 5° C. to about 8° C. Optionally, the exiting gas stream is dried by applying heat. Subsequently, the multi-component gaseous stream is compressed and then chilled, as described above. The dried multi-component gaseous stream may be compressed to a pressure of about 100 atm to about 200 atm, for example from about 120 atm to about 180 atm, including from about 122 atm to about 160 atm. Subsequently, the temperature to which the compressed gas is chilled ranges, in certain embodiments, from about −5° C. to about 15° C., such as from about 1° C. to about 10° C., including from about 4° C. to about 8° C., for example 5° C. to about 7° C. No further pretreatment or processing of the multi-component gaseous stream is required.

In other embodiments, the multi-component synthesis gas stream may be compressed prior to being subjected to the water gas shift reaction. In these embodiments, the multi-component synthesis gas stream is first compressed, and then subjected to the water gas shift reaction.

In certain embodiments of the invention, CO₂ hydrate formation is conducted in a single-stage, multi-step process, employing two or more CO₂ hydrate reactors. For example, CO₂ hydrate formation may be conducted in a single-stage, two-step process, which uses a first step hydrate reactor and a second step hydrate reactor, where the hydrate formation reaction mixture is transferred directly from the first step hydrate reactor to the second step hydrate reactor.

In the CO₂ hydrate formation reaction, the compressed and cooled multi-component gaseous stream is first fed to the first CO₂ hydrate reactor where the multi-component gaseous stream is contacted with an aqueous fluid under first CO₂ hydrate-formation reaction conditions. Upon contact of the multi-component gaseous stream with the aqueous fluid, CO₂ is selectively removed from the gaseous stream by the formation of CO₂ hydrates, which are formed as the CO₂ reacts with the CO₂ nucleated water liquid phase containing CO₂ hydrate precursors. Hydrogen and trace gases do not form hydrates, and remain as gases. The product of the first CO₂ hydrate reactor is a mixture that includes a CO₂ hydrate slurry comprising about 45-60 weight percent CO₂ hydrate and a multi-component gaseous stream depleted in CO₂. This product mixture exits the first step CO₂ hydrate reactor and is transferred directly from the first step CO₂ hydrate reactor into a second step CO₂ hydrate reactor where the mixture is exposed to second CO₂ hydrate-formation reaction conditions. The product of the second step CO₂ hydrate reactor is a mixture that includes the CO₂ hydrate slurry and a multi-component gaseous stream further depleted in CO₂.

The hydrate formation conditions under which the gaseous and liquid phase streams are contacted, particularly the temperature and pressure, may vary. In certain embodiments, the contacting occurs under first CO₂ hydrate-formation reaction conditions. In these embodiments, the temperature in the first step hydrate reactor at which the gaseous and liquid phases are contacted will range from about 3° C. to about 10° C., such as from about 4° C. to about 8° C., including from about 5° C. to about 8° C. The total pressure of the environment in the first hydrate reactor in which contact occurs may range from about 100 atm to about 200 atm, for example from about 110 atm to about 180 atm, including from about 120 atm to about 160 atm. The CO₂ partial pressure in the first hydrate reactor in which contact occurs does not exceed, in certain embodiments, about 40 atm, and usually does not exceed about 80 atm. The minimum CO₂ partial pressure at which hydrates form, at these temperature conditions, without CO₂ hydrate promoters is generally less than about 30 atm, such as less than about 25 atm, and may be as low as 20 atm or lower.

In certain embodiments, the product mixture from the first CO₂ hydrate reactor exits the first step CO₂ hydrate reactor and is transferred directly from the first step CO₂ hydrate reactor into a second step CO₂ hydrate reactor where the mixture is exposed to second CO₂ hydrate-formation reaction conditions. In some embodiments, the temperature of the second step CO₂ hydrate reactor conditions is a temperature that is lower than the temperature of the first step CO₂ hydrate reactor conditions, i.e., the temperature of the first CO₂ hydrate reactor conditions is greater than the temperature of the second step CO₂ hydrate reactor conditions. In some cases, the temperature in the second hydrate reactor at which the gaseous and liquid phases are contacted will range from about −1° C. to about 6° C., such as from about 0° C. to about 4° C., including from about 0° C. to about 2° C., for example 0° C. to about 1° C. The total pressure of the environment in the second hydrate reactor in which contact occurs may range from about 100 atm to about 200 atm, such as from about 110 atm to about 180 atm, including from about 120 atm to about 160 atm, for example from about 115 atm to about 155 atm.

In certain embodiments, the temperatures of the first and second hydrate formation reaction conditions are maintained within a desired range of temperatures, as described above. In these cases, heat of formation energy from the first and second hydrate formation reactions is transferred to a coolant medium. A particular coolant material of interest is ammonia. In certain embodiments, for the first hydrate formation reaction, the ammonia coolant is maintained at a temperature ranging from about −7° C. to about 0° C., such as from about −6° C. to about −2° C., including from about −4° C. to about −2° C., at a pressure ranging from about 1 atm to about 15 atm, such as from about 3 atm to about 10 atm, including from about 3 atm to about 5 atm. In certain embodiments, for the second hydrate formation reaction, the ammonia coolant is maintained at a temperature ranging from about −10° C. to about 0° C., such as from about −7° C. to about −1° C., including from about −5° C. to about −3° C., at a pressure ranging from about 1 atm to about 15 atm, such as from about 3 atm to about 10 atm, including from about 3 atm to about 5 atm. In some embodiments the heat energy transferred to the coolant medium may be used to increase the temperature of the CO₂ hydrate slurry to achieve the desired flash reactor conditions, as described below.

The CO₂ concentration in the multi-component gaseous stream exiting the first CO₂ hydrate reactor ranges, in certain embodiments, from about 25 to about 80 weight percent CO₂, such as from about 30 to about 60 weight percent CO₂, including from about 35 to about 40 weight percent CO₂. In other words, in certain embodiments, the first hydrate reactor step facilitates removal of about 20 to about 75 weight percent CO₂, such as from about 40 to about 70 weight percent CO₂, including from about 50 to about 65 weight percent of the CO₂ from the multi-component gaseous stream. The CO₂ concentration in the multi-component gaseous stream exiting the second step CO₂ hydrate reactor will, in certain embodiments, have been reduced to about 50 weight percent or less CO₂, such as from about 25 weight percent or less CO₂, including from about 10 weight percent or less CO₂. In other words, in certain embodiments, the first and second hydrate reactor steps combined facilitate the removal of about 50 weight percent or more CO₂, such as from about 75 weight percent or more CO₂, including from about 90 weight percent or more of the CO₂ from the multi-component gaseous stream.

The mixture then exits the second CO₂ hydrate reactor and is fed into a slurry/gas separator, where the CO₂ depleted multi-component gaseous stream and CO₂-rich slurry are separated. Additional stages may be employed if further extraction of CO₂ is desired. The ammonia vapor or other working coolant fluid produced in cooling the hydrate reactors may be used to regenerate CO₂ from the CO₂ hydrate slurries in subsequent flash reactor(s).

Any convenient gas-liquid phase separation means may be employed, where a number of such means are known in the art. In representative embodiments, the gas-liquid separator that is employed may be a vertical or horizontal separator with one or more, such as a plurality of, gas off-takes on the top of the separator. The subject invention provides for extremely high recovery rates of the multi-component gaseous stream. In other words, the amount of hydrogen and trace gases removed from the multi-component gas stream following selective CO₂ extraction according to the subject invention is extremely low. For example, where the multi-component gas stream is a syngas stream, the amount of gases (i.e., H₂) recovered is above about 85%, in certain embodiments above about 90%, and in certain embodiments above about 95%, where the amount recovered ranges in certain embodiments from about 85% to about 99%.

Separation of the slurry and gaseous products of the hydrate formation reactors produces separate CO₂ hydrate slurry and CO₂ depleted gaseous product streams, each at slighted reduced pressures as compared to the hydrate reactor pressures, whereby slightly reduced pressure is meant a pressure ranging from about 95 atm to about 195 atm, such as from about 105 atm to about 155 atm, including from about 115 atm to about 150 atm. In certain embodiments, the gaseous product stream is expanded to necessary design pressures in order to recover initial compression energy, and/or may be heated utilizing recovered compression heat energy. For example, in some cases, compression energy from the initial compressed multi-component gaseous stream is transferred to the gaseous product stream to increase the temperature of the gaseous product stream. Compression energy may be recovered from the initial multi-component stream using any convenient protocol, such as by passing the gas through an expander and/or heat exchanger, or the like. Such embodiments provide significant benefits with respect to reducing overall net energy requirements of the process, which in turn provides for more efficient CO₂ separation.

Where desired, high-pressure CO₂ gas may be regenerated from the CO₂ hydrates, e.g. where high pressure CO₂ gas is to be a product or further processed for sequestration. The resultant CO₂ gas may be disposed of by transport to the deep ocean or ground aquifers, or used in a variety of processes, e.g. enhanced oil or gas recovery, coal bed methane recovery, or further processed to form metal carbonates, e.g. MgCO₃, for fixation and sequestration.

In certain embodiments, the CO₂ hydrate slurry is treated in a manner sufficient to decompose the CO₂ hydrate slurry into high pressure CO₂ gas and a high pressure CO₂ nucleated water stream, i.e., the CO₂ hydrate slurry is subjected to a decomposition step. In certain embodiments, the CO₂ hydrate slurry is thermally treated, e.g. flashed in a flash reactor/regenerator, whereby thermally treated is meant that the temperature of the CO₂ hydrate slurry is raised in sufficient magnitude to decompose the hydrates and produce CO₂ gas. In certain embodiments, the subject process may include producing CO₂ gas from the CO₂ hydrate slurry in at lest one flash reactor. In some cases, producing the CO₂ gas occurs in a first flash reactor and a second flash reactor arranged in series. In these cases, the first flash reactor and second flash reactor are arranged such that the product from the first flash reactor flows directly from the first flash reactor to the second flash reactor.

In certain embodiments, the temperature of the CO₂ hydrate slurry in the first flash reactor is raised to a temperature of between about 10° C. to about 25° C., such as about 11° C. to about 18° C., including about 12° C. to about 15° C., at a pressure ranging from about 30 atm to about 60 atm, such as from about 40 atm to about 50 atm, including from about 40 atm to about 45 atm. One convenient means of thermally treating the CO₂ hydrate slurry is in counterflow heat exchangers, where each heat exchanger comprises a heating medium in a containment means that provides for optimal surface area contact with the hydrate slurry. Any convenient heating medium may be employed, where specific heating media of interest include, but are not limited to ammonia, HCFCs vapors, and the like. In some embodiments, the heating medium is ammonia vapor at a temperature ranging from about 30° C to about 80° C. In certain embodiments, the ammonia vapor is that vapor produced in cooling the nucleation and/or hydrate formation reactors, as described in greater detail above.

In certain embodiments, the first flash reactor and the second flash reactor are arranged in series, such that the CO₂ hydrate slurry is transferred directly from the first flash reactor into the second flash reactor. In some cases, the gaseous CO₂ leaving the first flash reactor is at a pressure of about 30 atm to about 50 atm, such as from about 40 atm to about 50 atm, including from about 42 atm to about 45 atm. In some cases, the temperature of the CO₂ hydrate slurry in the second flash reactor is maintained at a temperature substantially the same as the temperature of the first flash reactor, i.e., at a temperature of between about 10° C. to about 25° C., such as about 11° C. to about 18° C., including about 12° C. to about 15° C. The term “substantially the same” as used herein refers to a value that is at least about 60% identical, or about 75% identical, or about 90-95% identical to another value. In some instances, the internal environment of the second flash reactor is at a pressure ranging from about 10 atm to about 30 atm, such as from about 15 atm to about 19 atm, including from about 16 atm to about 18 atm. In some cases, the gaseous CO₂ leaving the second flash reactor is at a pressure of about 10 atm to about 30 atm, such as from about 15 atm to about 19 atm, including from about 16 atm to about 18 atm.

In some embodiments, the pressure of the flash-regenerated CO₂ from the second flash reactor is less than the pressure of the flash-regenerated CO₂ from the first flash reactor. In other words, in some embodiments, the pressure of the flash-regenerated CO₂ from the first flash reactor is greater than the pressure of the flash-regenerated CO₂ from the second flash reactor. In these embodiments, the pressure of the flash-regenerated CO₂ from the second flash reactor may be increased to a pressure substantially the same as the pressure of the flash-regenerated CO₂ from the first flash reactor by compressing the CO₂ to substantially the same pressure as the CO₂ from the first flash reactor. Subsequently, the flash-regenerated CO₂ from the second flash reactor may be combined with the flash-regenerated CO₂ from the first flash reactor. Where desired, the pressure of the combined CO₂ product gas may be increased to a third pressure that is greater than the first flash reactor pressure. In these instances, the third pressure may range from about 70 atm to about 200 atm, such as from about 80 atm to about 180 atm, including from about 100 atm to about 150 atm. The pressure of the combined CO₂ product gas streams may be increased using any convenient means, e.g. a gas compressor, or the like. In certain embodiments, the high pressure CO₂ product gas stream may be cooled using a chiller, water cooler, or the like, and may be processed further, as necessary, for sequestration or for subsequent use as described above.

The high-pressure water streams produced in each flash reactor may be chilled, pumped and recycled to the hydrate reactors. Make-up water and/or nucleated water may be added as desired.

Multi-component gaseous streams that may be treated according to the subject methods include, but are not limited to synthesis gas streams and oxidizing condition streams, e.g. flue gases from combustion utilizing oxygen. Particular multi-component gaseous streams of interest that may be treated according to the subject invention include, but are not limited to syngas streams from the gasification of organic fuels, oxygen containing combustion power plant flue gas, and the like.

### Systems

Also provided are systems for use in practicing the subject methods. A feature of the subject systems is that they include at least: (a) at least two hydrate formation reactor steps; and (b) at least two hydrate flash reactors. In certain embodiments, the subject system includes a first step hydrate formation reactor and a second step hydrate formation reactor, where the first step hydrate formation reactor and the second step hydrate formation reactor are arranged in series, such that the mixture of a CO₂ hydrate slurry and a CO₂ depleted gaseous stream formed in the first step hydrate formation reactor, according to the methods described in detail above, flows directly from the first step hydrate formation reactor to the second step hydrate formation reactor. The hydrate formation reactors are arranged to provide for high-pressure CO₂ hydrate-formation reaction conditions, according to the methods described above.

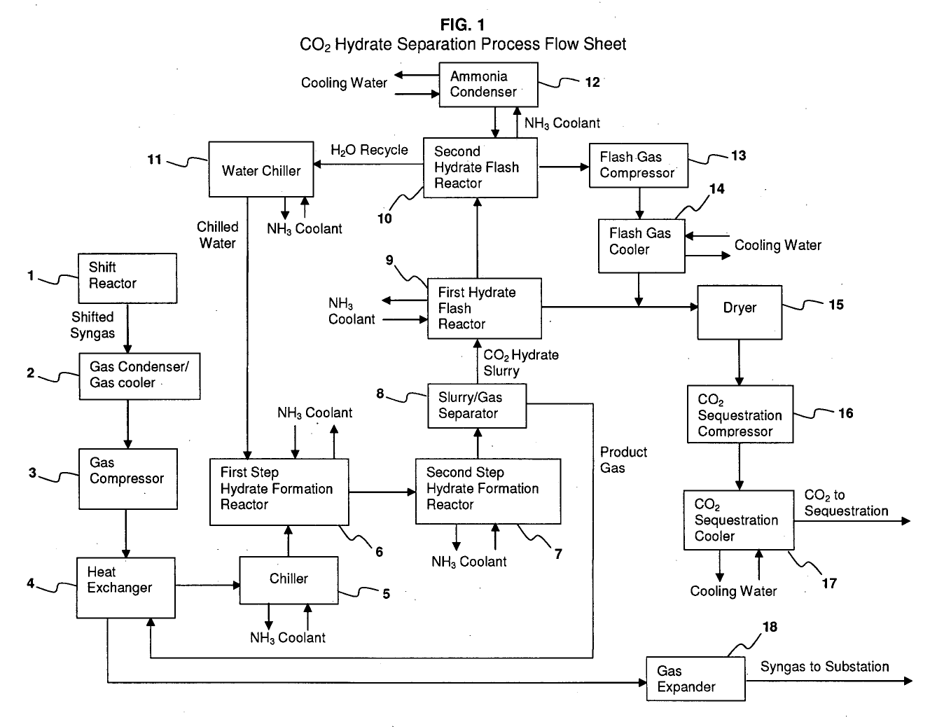

The invention will now be described further in terms of representative embodiments of the subject systems. One representative embodiment of the subject systems is shown schematically in FIG. 1, which provides a schematic flow diagram of a system for selectively removing CO₂ from a multi-component gaseous stream in a manner according to the present invention. In FIG. 1, synthesis gas, obtained as described above, is subjected to the water gas shift reaction in shift reactor 1. The shifted syngas is then introduced into a gas condenser/gas cooler 2. Water vapor is condensed and the exiting gas stream is compressed in a compressor 3. At least a portion of the heat energy from the compressed multi-component gaseous stream is transferred to the product gas stream in heat exchanger 4. The multi-component gaseous stream is then chilled in an ammonia chiller 5. The chilled multi-component gaseous stream is passed into a first step CO₂ hydrate formation reactor 6, which is cooled by ammonia coolant. The multi-component gaseous stream is contacted with chilled water in the first step CO₂ hydrate formation reactor 6. The chilled water is at a temperature of about 5° C. to about 7° C., and a pressure of about 120 atm to about 160 atm. The temperature in the first step hydrate reactor 6 at which the gaseous and liquid phases are contacted ranges from about 5° C. to about 8° C. The total pressure of the environment in the first step hydrate reactor 6 in which contact occurs ranges from about 120 atm to about 160 atm. Ammonia coolant is used to cool the first step hydrate reactor 6. The ammonia coolant for the first step hydrate reactor 6 is maintained at a temperature ranging from about −7° C. to about 0° C., and at a pressure ranging from about 3 atm to about 5 atm. The product, which has about 60-65 wt. % of the gaseous CO₂ extracted in the first step hydrate reactor 6 is transferred directly to a second step CO₂ hydrate formation reactor 7. The temperature in the second step hydrate reactor 7 ranges from about 0° C. to about 2° C. The total pressure of the environment in the second step hydrate reactor 7 ranges from about 115 atm to about 155 atm. Ammonia coolant is used to cool the second hydrate reactor 7. The ammonia coolant for the second hydrate reactor 7 is maintained at a temperature ranging from about −5° C. to about −3° C., and at a pressure ranging from about 3 atm to about 5 atm. An energy transfer element (not shown) may be arranged to transfer heat of formation energy from the first step hydrate reactor 6 and the second step hydrate reactor 7 to the first flash reactor 9 and the second flash reactor 10. The heat energy transferred to the coolant medium in the first step hydrate reactor 6 and the second step hydrate reactor 7 may be used to increase the temperature of the CO₂ hydrate slurry in the first flash reactor 9 and the second flash reactor 10 to achieve the desired flash reactor conditions and to minimize ammonia condenser cooling water requirements. About 25-30 wt. % of the first step gaseous CO₂ feed is extracted in the second step hydrate reactor 7. The product from the second hydrate reactor 7 is passed through a slurry/gas separator 8. The product gas stream from the slurry/gas separator 8 is passed through heat exchanger 4, where at least a portion of the heat energy from the initial compressed multi-component gaseous stream is transferred to the product gas stream in heat exchanger 4. The pressure of the product gas stream is reduced in gas expander 18, and the product gas stream is sent for further processing and/or to a substation pipeline. The separated CO₂ hydrate slurry from the slurry/gas separator 8 is sent to first CO₂ flash reactor 9. The temperature of first flash reactor 9 containing the CO₂ hydrate slurry is raised to a temperature of about 10° C. to about 25° C., at a pressure ranging from about 30 atm to about 60 atm. Ammonia vapor is condensed to maintain the temperature of first flash reactor 9, thereby increasing the process efficiency. The product from the first flash reactor 9 is sent directly to second CO₂ flash reactor 10. The temperature of the second flash reactor 10 containing the CO₂ hydrate slurry is maintained at a temperature substantially the same as the temperature of first flash reactor 9, e.g. at a temperature of about 10° C. to about 25° C. The pressure of second flash reactor 10 ranges from about 10 atm to about 30 atm. Ammonia vapor is condensed to maintain the temperature of the second flash reactor 10, thereby increasing process efficiency. The aqueous byproduct produced in flash reactors 9 and 10 may be recycled by a recycling element (not shown) to CO₂ hydrate reactors 6 and/or 7 after being cooled in water chiller 11. Energy from the aqueous byproduct may be recovered by an energy recovery element (not shown). The ammonia coolant from second flash reactor 10 may comprise ammonia vapor and ammonia liquid. The ammonia coolant from second flash reactor 10 is circulated through a water-cooled ammonia condenser 12 to condense any remaining ammonia vapor. The regenerated CO₂ from second flash reactor 10 is compressed in compressor 13 to a pressure substantially the same as the pressure of the flash-regenerated CO₂ from first flash reactor 9. The compressed CO₂ is cooled in water cooler 14. The compressed and cooled CO₂ from second flash reactor 10 is combined with the regenerated CO₂ from first flash reactor 9. The combined CO₂ gas stream is then dried in dryer 15. Dryer 15 may be any type of dryer known to those of skill in the art to be useful in the subject invention, such as but not limited to a molecular sieve dryer, thermal dryer, and the like. The dried CO₂ gas stream is compressed to high pressure, e.g. a pressure ranging from about 100 to about 150 atm, in final compressor 16. The high pressure CO₂ is cooled in water cooler 17, and the product high pressure CO₂ is sent to a pipeline for subsequent use or sequestration. A small portion (about 3% to about 5%) of the produced CO₂ may be chilled and recycled, if necessary, to resaturate with CO₂ the chilled water streams entering the first step CO₂ hydrate reactor 6 and/or second step CO₂ hydrate reactor 7.

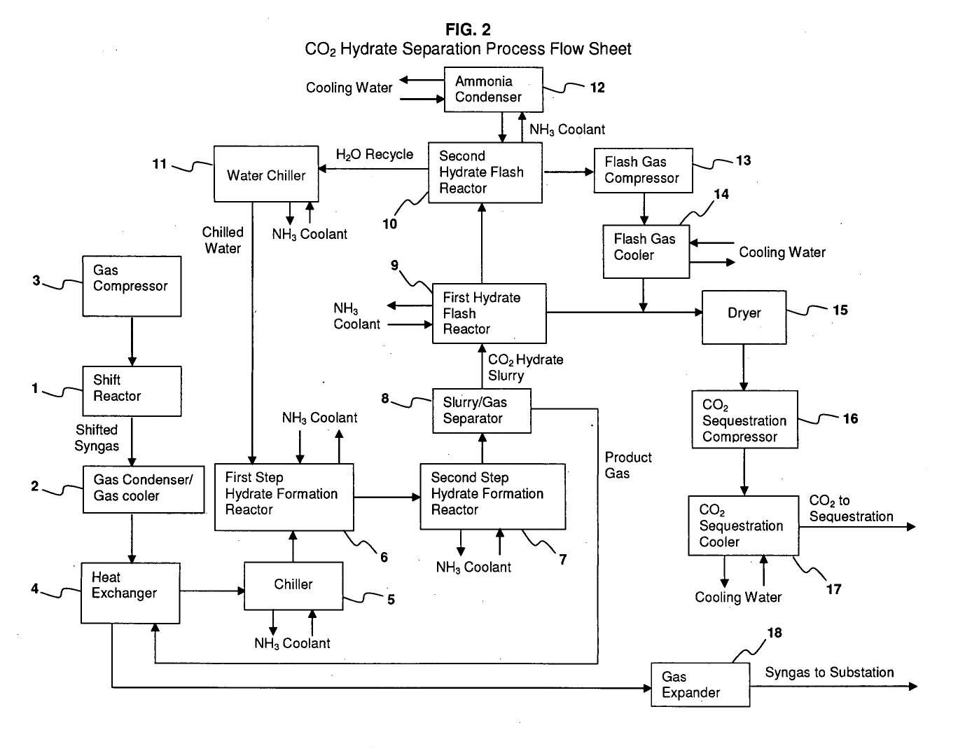

Another representative embodiment of the subject systems is shown schematically in FIG. 2, which provides a schematic flow diagram of a system for selectively removing CO₂ from a multi-component gaseous stream in a manner according to the present invention. In FIG. 2, synthesis gas, obtained as described above, is initially compressed in compressor 3 prior to being subjected to the water gas shift reaction in shift reactor 1. The resulting multi-component shifted syngas stream is then processed through the subject systems as described above to facilitate the selective removal of CO₂ from the multi-component gaseous stream.

The subject methods and systems provide for the resource efficient regeneration of high pressure CO₂ from a high pressure CO₂ hydrate reactor and slurry/gas separator. The subject methods and systems provide for numerous opportunities to reduce parasitic energy loss, and efficiently provide for separation of CO₂ from a multi-component gaseous stream to produce a high pressure CO₂ product gas. As such, the subject invention represents a significant contribution to the art.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method for removing CO₂ from a multi-component gaseous stream to produce a CO₂ depleted gaseous stream, said method comprising:
(a) contacting a multi-component gaseous stream with an aqueous fluid in a first step hydrate reactor under first hydrate-formation reaction conditions sufficient to produce a mixture comprising a CO₂ hydrate slurry and a gaseous stream depleted in CO₂;
(b) transferring said mixture directly from said first step hydrate reactor to a second step hydrate reactor;
(c) exposing said mixture in said second step hydrate reactor to second hydrate-formation reaction conditions sufficient to produce CO₂ hydrate slurry and a gaseous stream further-depleted in CO₂; and
(d) separating said gaseous stream further-depleted in CO₂ from said CO₂ hydrate slurry to remove CO₂ from said multi-component gaseous stream.

2. The method of claim 1, wherein said aqueous fluid is CO₂ nucleated water.

3. The method of claim 1, wherein the method does not include use of CO₂ hydrate promoters.

4. The method of claim 1, wherein said first hydrate-formation reaction conditions and said second hydrate-formation reaction conditions comprise a pressure, wherein said pressure ranges from about 110 atm to about 180 atm.

5. The method of claim 1, wherein said first hydrate-formation reaction conditions comprise a first temperature and said second hydrate-formation reaction conditions comprise a second temperature, and wherein said first temperature is greater than said second temperature.

6. The method of claim 1, wherein said first hydrate-formation reaction conditions comprise a first temperature that ranges from about 5° C. to about 8° C.

7. The method of claim 1, wherein said second hydrate-formation reaction conditions comprise a second temperature that ranges from about 0° C. to about 2° C.

8. The method of claim 1, further comprising:
increasing the pressure of said multi-component gaseous stream to produce a compressed multi-component gaseous stream; and
reducing the temperature of said compressed multi-component gaseous stream, wherein heat energy from said compressed multi-component gaseous stream is transferred to a coolant medium,
wherein said increasing the pressure and said reducing the temperature occur prior to said contacting step (a).

9. The method of claim 8, further comprising increasing the temperature of said gaseous stream further-depleted in CO₂ by transferring heat energy from said coolant medium to said gaseous stream further-depleted in CO₂.

10. The method of claim 8, wherein the pressure of said compressed multi-component gaseous stream ranges from about 100 atm to about 180 atm.

11. The method of claim 1, further comprising producing CO₂ gas from said CO₂ hydrate slurry from step (d) in at least one flash reactor.

12. The method of claim 11, wherein said producing comprises increasing the temperature of said CO₂ hydrate slurry by transferring heat of formation energy obtained from said contacting step (a) and said exposing step (c) to said CO₂ hydrate slurry.

13. The method of claim 11, wherein said producing occurs in a first flash reactor and a second flash reactor arranged in series.

14. The method of claim 13, wherein said first flash reactor is at a first flash reactor pressure and said second flash reactor is at a second flash reactor pressure, and wherein said first flash reactor pressure is greater than said second flash reactor pressure.

15. The method of claim 13, wherein said first flash reactor pressure ranges from about 30 atm to about 60 atm and said second flash reactor pressure ranges from about 10 atm to about 30 atm.

16. The method of claim 13, wherein said CO₂ gas produced by said first flash reactor has a pressure greater than said CO₂ gas produced by said second flash reactor.

17. The method of claim 16, further comprising:
compressing said CO₂ gas produced by said second flash reactor to a pressure substantially the same as said CO₂ gas produced by said first flash reactor; and
combining said CO₂ gas produced by said first flash reactor with said compressed CO₂ gas from said second flash reactor into a combined CO₂ gas stream at a pressure substantially the same as the pressure of said CO₂ gas produced by said first flash reactor.

18. The method of claim 17, further comprising sequestering said combined CO₂ gas stream.

19. The method of claim 17, further comprising compressing said combined CO₂ gas stream to a third pressure that is greater than the pressure of said CO₂ gas produced by said first flash reactor.

20. The method of claim 19, wherein said third pressure ranges from about 100 atm to about 150 atm.

21. A system for removing CO₂ from a multi-component gaseous stream to produce a CO₂ depleted gaseous stream, said system comprising:
(a) a first step hydrate formation reactor;
(b) a second step hydrate formation reactor; and
(c) at least two flash reactors arranged to produce CO₂ gas from a CO₂ hydrate slurry,
wherein said first step hydrate formation reactor and said second step hydrate formation reactor are arranged in series, and wherein said first step hydrate formation reactor and said second step hydrate formation reactor are arranged to form a mixture comprising said CO₂ hydrate slurry and a CO₂ depleted gaseous stream from a multi-component gaseous stream, wherein said mixture flows directly from said first step hydrate formation reactor to said second step hydrate formation reactor.

22. The system of claim 21, further comprising a slurry/gas separator to separate said CO₂ hydrate slurry from said CO₂ depleted gaseous stream.

23. The system of claim 21, further comprising a first gas compressor arranged to compress said multi-component gaseous stream.

24. The system of claim 23, further comprising at least one compression energy recovery element arranged to recover compression energy from said compressed multi-component gaseous stream.

25. The system of claim 21, comprising a first flash reactor and a second flash reactor arranged in series.

26. The system of claim 25, wherein said first flash reactor is at a first flash reactor pressure and said second flash reactor is at a second flash reactor pressure, and wherein said first flash reactor pressure is greater than said second flash reactor pressure.

27. The system of claim 25, further comprising a second gas compressor downstream from said second flash reactor.

28. The system of claim 27, further comprising a third gas compressor downstream from said second gas compressor.

29. The system of claim 21, further comprising at least one energy transfer element arranged to transfer heat of formation energy from said first step hydrate formation reactor and said second step hydrate formation reactor to said flash reactors.

30. The system of claim 21, further comprising a recycling element arranged to recycle an aqueous byproduct from said flash reactors to said first step hydrate formation reactor and said second step hydrate formation reactor.

31. The system of claim 30, further comprising an energy recovery element arranged to recover energy from said aqueous byproduct.
